(19) United States
(12) Patent Application Publication
(10) Pub. No.: US 2002/0088744 A1
(43) Pub. Date: Jul. 11, 2002

(54) Well screen having a line extending therethrough

(76) Inventors: Ralph H. Echols, Dallas, TX (US); Henry L. Restarick, Carrollton, TX (US); Michael Feechan, Sagamore, MA (US)

Correspondence Address: Marlin R. Smith, Esq., Konneket & Smith, P.C., Suite 230, 660 North Central ExPwy, Plano, TX, 75074, US

(21) Appl. No.: 09/758,625

(22) Filed: Jan. 11, 2001

(51) Int. Cl. B01D 35/02

(52) U.S. Cl. 210/170; 210/85; 210/143; 210/455; 210/483

(57) ABSTRACT

A well screen is provided which includes a line extending therethrough. In a described embodiment, the line may be a hydraulic line, an electric line, a fiber optic line, or another type of line, and the line may be embedded in a sidewall material of the well screen. The well screen may be wrapped about a reel as a part of a coiled tubing string, and the well screen may be expandable when deployed in a wellbore. In another embodiment, the line may be positioned between a filter media and an outer shroud of the well screen.

### BACKGROUND

The present invention relates generally to equipment utilized in conjunction with a subterranean well and, in an embodiment described herein, more particularly provides a well screen having a line extending therethrough.

It is quite common to utilize lines extending into a well in order to perform certain functions, such as operating an actuator, monitoring well conditions, communicating data, etc. At times, such lines are used where well screens are interconnected in a tubing string. In these situations, it is usually difficult to run the lines across the well screens.

For example, if the lines are attached to the tubing string so that they run externally across the screens, an outer dimension of the tubing string is increased. Since the screens are typically larger in diameter already compared to tubing in the tubing string, this dimensional increase due to the external lines further restricts passage of the tubing string through a given wellbore. In addition, the external lines are exposed to damage while running the tubing string, and are exposed to erosion due to fluid flow into the screens.

If the lines are run internally through the screens, the lines restrict fluid flow and equipment passage through the screens. Furthermore, the lines are exposed to erosion due to fluid flow through the screens, and are exposed to damage when equipment is run through the screens.

From the foregoing, it can be seen that it would be quite desirable to provide a method of extending lines through well screens, so that the lines are protected during conveyance of a tubing string into a well and during production of the well, and so that the lines do not restrict the conveyance of the tubing string in the well and do not restrict passage of equipment through the screens. It is accordingly an object of the present invention to provide such well screens having lines extending therethrough.

### SUMMARY

In carrying out the principles of the present invention, in accordance with described embodiments thereof, well screens are provided which include lines extending therethrough. In one embodiment, the Lines are embedded in a material in a sidewall of the screen. In another embodiment, the lines extend between a filter media and an outer shroud of the screen.

In one aspect of the invention, the screen is configured for use with a coiled tubing string. The screen may have an outer dimension less than or approximately equal to an outer diameter of tubing in the coiled tubing string, so that conventional injector heads used to run the tubing may be used for running the screen as well. The screen may be wrapped about a reel for ease of deployment with the coiled tubing string.

In another aspect of the invention, the screen may be conveniently integrated into the coiled tubing string. For example, the screen may be formed continuously on the coiled tubing string, with there being no need to sever the tubing in order to interconnect the screen in the coiled tubing string. Instead, the screen is formed at a predetermined location in the coiled tubing string by forming openings through a sidewall of the tubing. The predetermined location corresponds to a desired position of the screen when the tubing string is deployed into a well. Multiple screens may be formed on the tubing string spaced apart to correspond to a desired screen spacing in the well.

In yet another aspect of the invention, the screen may be expandable. In this manner, a coiled tubing string may be deployed into a well with the expandable screen interconnected therein, and the screen expanded after it is appropriately positioned in the well.

In a further aspect of the invention, the line in the screen may be connected to various sensors, actuators and flow control devices. The line may also be connected to a tractor device, which conveys the tubing string including the screen in the well.

These and other features, advantages, benefits and objects of the present invention will become apparent to one of ordinary skill in the art upon careful consideration of the detailed description of representative embodiments of the invention hereinbelow and the accompanying drawings.

### BRIEF DESCRIPTION OF THE DRAWINGS

FIG. 1 is a schematic partially cross-sectional view of a prior art method of deploying well screens and lines in a well;

FIG. 2 is a schematic partially cross-sectional view of a first well screen embodying principles of the present invention;

FIG. 3 is a schematic cross-sectional view of the first well screen, taken along line 3-3 of FIG. 2;

FIG. 4 is a schematic side view of a first well screen deployment system embodying principles of the present invention;

FIG. 5 is a schematic side view of a second well screen deployment system embodying principles of the present invention;

FIG. 6 is a schematic quarter-sectional view of a third well screen embodying principles of the present invention;

FIG. 7 is a schematic quarter-sectional view of a fourth well screen embodying principles of the present invention;

FIG. 8 is an enlarged scale cross-sectional view of an alternate construction which may be used with the first, second and third well screens;

FIG. 9 is a partially cross-sectional view of a well production system embodying principles of the present invention;

FIGS. 10A & B are schematic quarter-sectional views of a, fourth well screen embodying principles of the present invention, the fourth screen being shown in a retracted configuration in FIG. 10A, and in an expanded configuration in FIG. 10B; and

FIG. 11 is a schematic quarter-sectional view of a fifth well screen embodying principles of the present invention.

### DETAILED DESCRIPTION

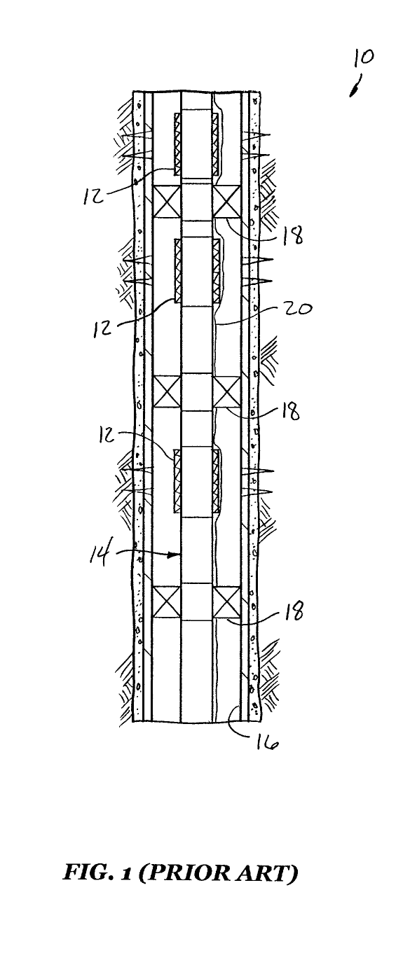

Representatively illustrated in FIG. 1 is a prior art method 10. In the following description of the method 10 and other apparatus and methods described herein, directional terms, such as “above”, “below”, “upper”, “lower”, etc., are used only for convenience in referring to the accompanying drawings. Additionally, it is to be understood that the various embodiments of the present invention described herein may be utilized in various orientations, such as inclined, inverted, horizontal, vertical, etc., and in various configurations, without departing from the principles of the present invention.

In the method 10, individual well screens 12 are interconnected in a tubing string 14 as the tubing string is lowered into a wellbore 16. The tubing string 14 may include other items of equipment, such as packers 18, etc. As each item of equipment or separate stand of tubing is interconnected to the tubing string 14, the conveyance of the tubing string into the wellbore 16 must be halted, the item of equipment or stand of tubing must be connected (usually, threaded to the top of the tubing string, torqued up and pressure tested), and then the tubing string is again lowered into the wellbore until the next item of equipment or stand of tubing is added.

If lines 20 are to be run with the tubing string 14, they are typically run externally as shown in FIG. 1. While the tubing string 14 is being run into the wellbore 16, the lines 20 are usually strapped to the outside of the tubing string.

Unfortunately, this leaves the lines 20 exposed to damage and increases the outer dimension of the tubing string 14.

A fairly recent innovation is described in U.S. Pat. No. 6,082,454, wherein screens are run into a well interconnected in a coiled tubing string. This method eliminates the need to halt conveyance of the tubing string while the well screens or stands of tubing are interconnected in the tubing string, but it substitutes another inconvenience in that a special deployment rig with variable opening injector heads must be used to accommodate the screens, which have a larger diameter than the tubing on a reel of coiled tubing. The method also does not solve the problem of running lines with the tubing string, as the method is described with the lines being run external to the tubing string. The disclosure of U.S. Pat. No. 6,082,454 is incorporated herein in its entirety by this reference.

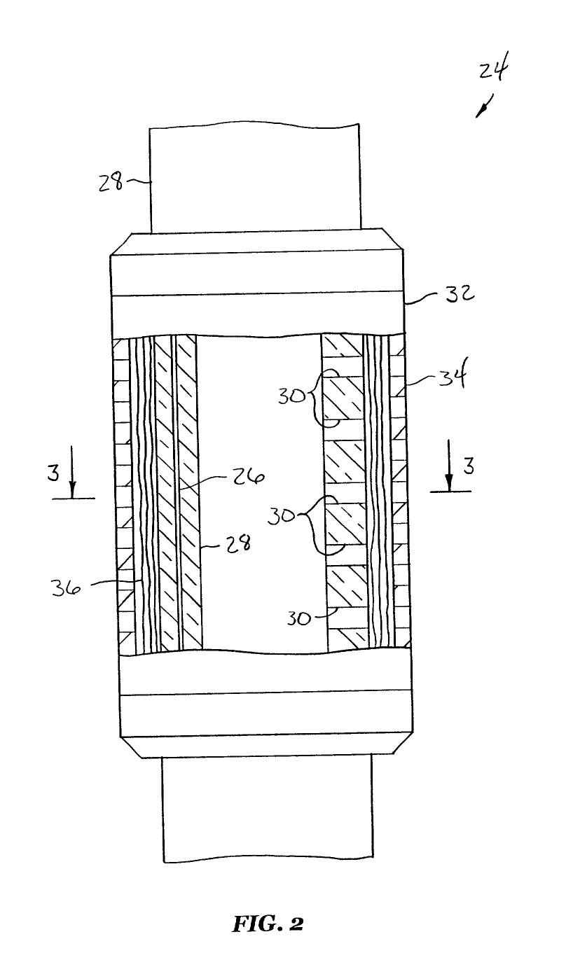

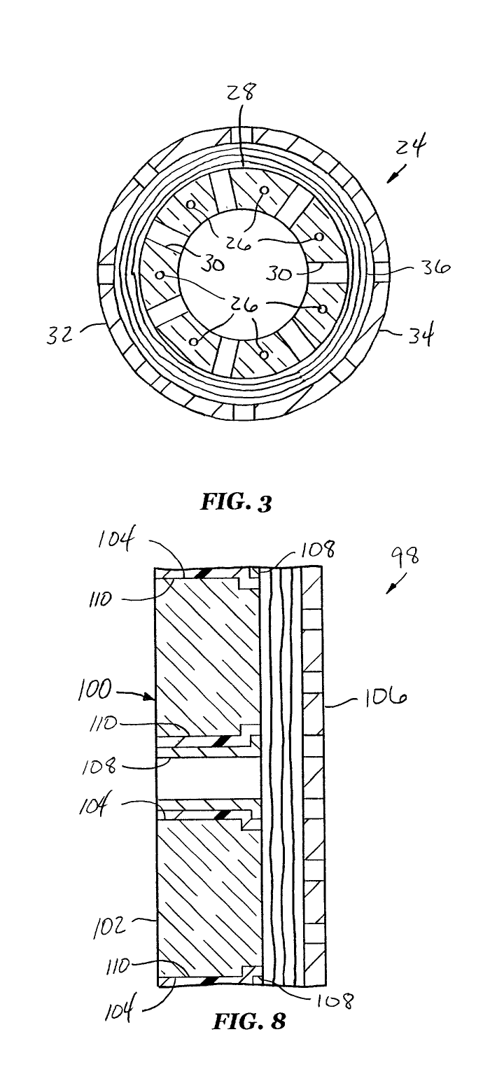

Referring additionally now to FIG. 2, a well screen 24 embodying principles of the present invention is representatively illustrated. The screen 24 solves the problem of running lines with well screens in a tubing string. Specifically, the screen 24 includes lines 26 (only one of which is visible in FIG. 1, see FIG. 3) embedded in a sidewall material of the screen.

The screen 24 includes a tubular base pipe or body portion 28. The base pipe 28 is preferably made of a nonmetallic material in which the lines 26 may be embedded during manufacture of the base pipe. Most preferably, the base pipe 28 is made of a composite material specially adapted for use in a well.

Openings 30 are formed through the base pipe 28 to permit fluid flow through the screen sidewall. A screen jacket 32 outwardly overlies the openings 30. The screen jacket 32 includes an outer perforated shroud 34 and filter media 36.

In the embodiment depicted in FIG. 2, the filter media 36 is made up of three layers of woven material sintered together, and the filter media is in turn sintered to the outer shroud. Such a screen jacket 32 is described in U.S. patent application Ser. No. 09/574,658, filed May 18, 2000, the disclosure of which is incorporated herein in its entirety by this reference. However, it is to be clearly understood that otherwise configured screen jackets and other types of filter media may be used, without departing from the principles of the present invention.

Referring additionally now to FIG. 3, a cross-sectional view of the screen 24 is shown. Note that the lines 26 are alternated circumferentially with the openings 30 in the base pipe 28, and that seven of the lines are depicted. The lines 26 may be hydraulic, electric and/or fiber optic lines, and the lines may be used for communications, chemical injection, supplying power, controlling a downhole process, monitoring downhole conditions, etc. Of course, other types of lines may be used, and the lines may be used for other purposes, in keeping with the principles of the invention.

The screen 24 may be used in a method, such as the method lo described above or the method described in the U.S. Pat. No. 6,082,454 discussed above, wherein the screen is interconnected in a coiled tubing string conveyed into a well. In that case, the lines 26 do not have to be run externally across the screen 24, but instead extend through a sidewall of the screen. In that case, suitable connections, such as threaded connections, would be provided at each end of the base pipe 28.

Alternatively, the screen 24 could be formed directly on coiled tubing. The coiled tubing would be provided with the lines 26 extending in a sidewall of the tubing. In this case, the base pipe 28 would correspond to a portion of the coiled tubing. At a location on the coiled tubing 28 corresponding to a desired position of the screen 24 in a well, the openings 30 would be formed through the tubing sidewall, and the screen jacket 32 would be installed over the openings.

This method permits the screen 24 to be formed continuously on the coiled tubing, without the need to sever the tubing in order to form connections between the tubing and the screen. This method also permits the coiled tubing string to be conveyed into a well without halting to interconnect the screen 24 in the tubing string. Furthermore, this method permits any practical length of the screen 24 to be continuously formed on the coiled tubing, since the screen may be deployed from a reel with the rest of the coiled tubing, and thus its length is not limited by the height of a rig at the well, or the need to have a rig at the well at all.

Still further, any number of the screens 24 may be formed on coiled tubing. The screens 24 may be spaced apart on the coiled tubing when it is on the reel so that, when the coiled tubing is deployed into the well, the spacing of the screens corresponds to predetermined desired spacings between the screens in the well. For example, if in the method 10 described above a well screen 24 is substituted for each of the screens 12, and the tubing string 14 is a coiled tubing string having the screens continuously formed on the coiled tubing then, prior to deployment of the tubing string 14 into the wellbore 16 the screens 24 may be spaced apart at predetermined locations corresponding to their respective desired positions in the well after deployment.

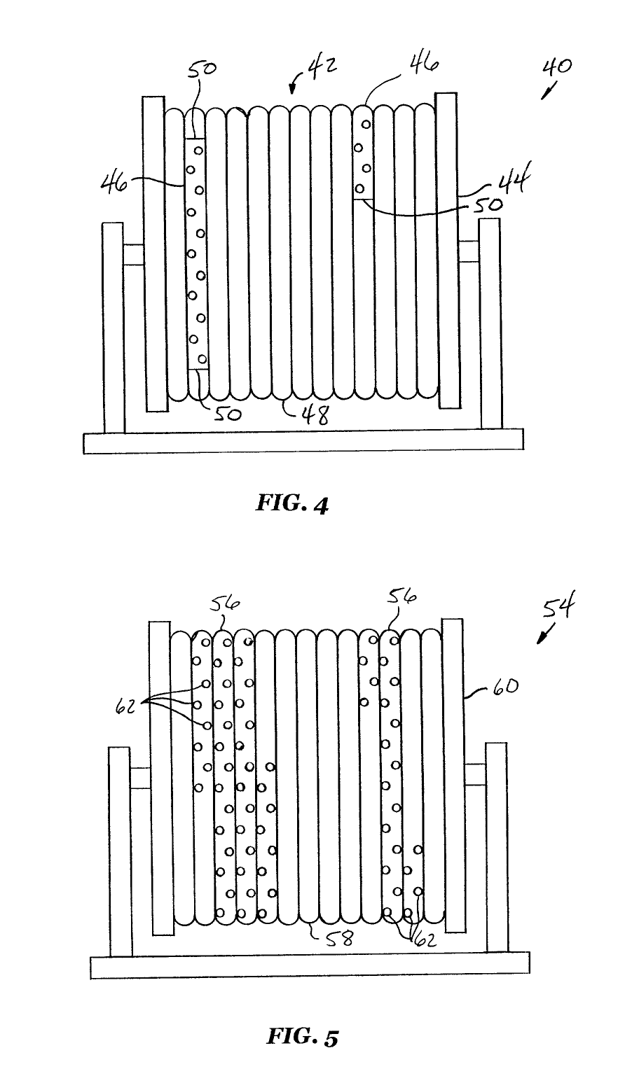

Referring additionally now to FIG. 4, a well screen deployment system 40 embodying principles of the present invention is representatively illustrated. In the system 40, a coiled tubing string 42 is wrapped on a reel 44. Of course, the use of reels for deployment of coiled tubing strings is well known to those skilled in the art. However, in the system 40, well screens 46 are interconnected to coiled tubing 48 and are spaced apart on the reel 44 at predetermined locations corresponding to predetermined desired spacings between the screens in a well.

The coiled tubing 48 is preferably made of a composite or other nonmetallic material having lines, such as the lines 26 described above, embedded therein. The screens 46 are separately constructed and are interconnected to the coiled tubing 48 using connections 50. The screens 46 also have lines, such as the lines 26, extending therethrough. Thus, the connections 50 structurally connect the screens 46 to the tubing 48 and interconnect the lines 26 to each other between the screens and tubing.

Note that an outer diameter of the screens 46 is less than or approximately equal to an outer diameter of the tubing 48. Preferably, the outer diameter of the screens 46 is the same as the outer diameter of the tubing 48. By constructing the tubing string 42 in this manner, no specially configured variable width injector heads are needed to deploy the tubing string into a well. Instead, the tubing string 42 may be deployed using conventional coiled tubing equipment.

Referring additionally now to FIG. 5, another well screen deployment system 54 embodying principles of the present invention is representatively illustrated. In the system 54, screens 56 are formed continuously on tubing 58 wrapped on a reel 60. As in the system 40, the screens 56 are spaced apart on the reel 60 at predetermined locations corresponding to predetermined desired spacings between the screens in a well.

The screens 56 are formed on the tubing 58 by forming openings 62 through a sidewall of the tubing. The openings 62 are depicted in FIG. 5 as being circular holes, but it is to be clearly understood that the openings 62 may be otherwise configured, for example, as slots, etc. In the embodiment depicted in FIG. 5, the openings 62 filter fluid flowing into the tubing 58.

The coiled tubing 58 is preferably made of a composite or other nonmetallic material having lines, such as the lines 26 described above, embedded therein. Thus, by forming the screens 56 directly on the tubing 58, the screens 56 also have the lines 26 extending through their sidewalls.

Note that the screens 56 could each have a screen jacket, such as the screen jacket 32 described above, installed overlying the openings 62. In that case, the screens 56 would be similar to the screen 24, with the base pipe 28 corresponding to the coiled tubing 58.

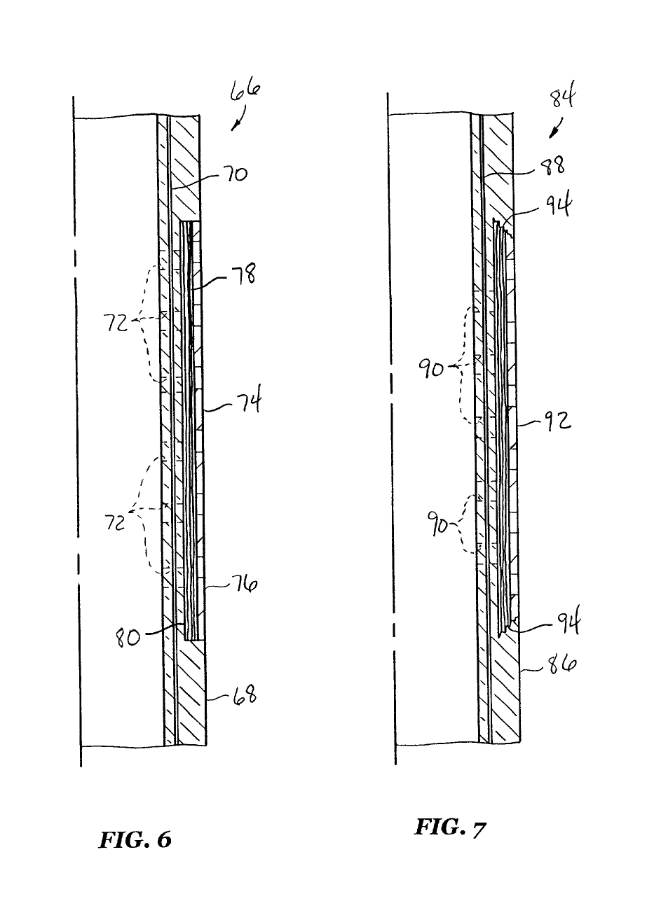

Referring additionally now to FIG. 6, a well screen 66 embodying principles of the present invention is representatively illustrated. The well screen 66 may be used for any of the screens 46, 56 described above, or it may be used in other screen deployment systems. The screen 66 is particularly suited for use in the deployment systems 40, 54 described above, since the screen has a flush outer diameter, and thus it maybe conveniently wrapped on a reel, and it may be deployed into a wellbore using conventional injector heads.

The screen 66 includes a body portion or base pipe 68 with one or more lines 70 embedded in a sidewall thereof. The lines 70 may be similar to the lines 26 described above and maybe used to perform any of a variety of functions.

Preferably, the material of which the base pipe 68 is made is a nonmetallic composite material for convenience in embedding the lines 70 therein, but other materials may be used for the base pipe 68 in keeping with the principles of the present invention. If the screen 66 is used for one of the screens 46 in the deployment system 40, then the base pipe 68 would be separately constructed from the tubing 48. If the screen 66 is used for one of the screens 56 in the deployment system 54, then the base pipe 68 would be a portion of the tubing 58, i.e., the screen would be continuously formed on the tubing without severing the tubing.

Openings 72 are formed through the base pipe 68 sidewall to permit fluid flow therethrough. The openings 72 and lines 70 may be alternated circumferentially in the base pipe 68 sidewall in a manner similar to that described above and depicted in FIG. 3 for the lines 26 and openings 30. Any number of lines 70 and openings 72 may be provided.

The screen 66 includes a screen jacket 74 outwardly overlying the openings 72. The screen jacket 74 may be similar to the screen jacket 32 described above, in that it includes a perforated outer shroud 76 and a multilayered filter media 78. However, other types of screen jackets or other filtering devices may be used in place of the screen jacket 74, without departing from the principles of the present invention.

The screen jacket 74 is installed in a recess 80 formed externally on the base pipe 68. In this manner, the screen jacket 74 does not extend outwardly beyond the outer diameter of the base pipe 68. Thus, when the screen 66 is interconnected in a coiled tubing string and wrapped on a reel, the screen does not interfere with the wrapping of the tubing on the reel, and does not require special equipment when the tubing string is deployed from the reel.

Referring additionally now to FIG. 7, a well screen 84 embodying principles of the present invention is representatively illustrated. The screen 84 is similar in many respects to the screen 66, in that it includes a base pipe 86, lines 88, openings go, and screen jacket 92 similar to the base pipe 68, lines 70, openings 72 and screen jacket 74 of the screen 66. However, the screen jacket 92 of the screen 84 is attached to the base pipe 86 using ridges or serrations 94.

The serrations 94 serve to provide a gripping attachment between the screen jacket 92 and the base pipe 86. The serrations 94 also provide an enhanced seal between the screen jacket 92 and the base pipe 86. Of course, other attachment means and other sealing means may be used in keeping with the principles of the invention.

Referring additionally now to FIG. 8, an alternate well screen construction 98 embodying principles of the present invention is representatively illustrated. The alternate construction 98 may be used in conjunction with well screens described herein.

A sidewall portion of a screen 100 is depicted in FIG. 8, which includes a base pipe 102 having openings 104 formed therethrough and a screen jacket 106 outwardly overlying the openings 104. The base pipe 102 is preferably made of a composite material, which has several advantages over conventional metal tubing, such as reduced weight, the ability to embed lines therein, etc.

However, many composite materials are more susceptible to erosion damage as compared to metals. For this reason, the screen 100 includes generally tubular shields or inserts 108 lining the openings 104 in the base pipe 102. The inserts 108 may be made of metal or any other erosion resistant material.

To provide a resilient or flexible gripping force for installing the inserts 108 in the openings 104, retainers 11o are used between the inserts and the openings. The retainers lo are preferably made of a rubber compound or other resilient material, and the retainers may also provide seals between the inserts 108 and the openings 104. Of course, other materials may be used for the retainers 110, and other gripping and/or sealing means may be used, without departing from the principles of the present invention.

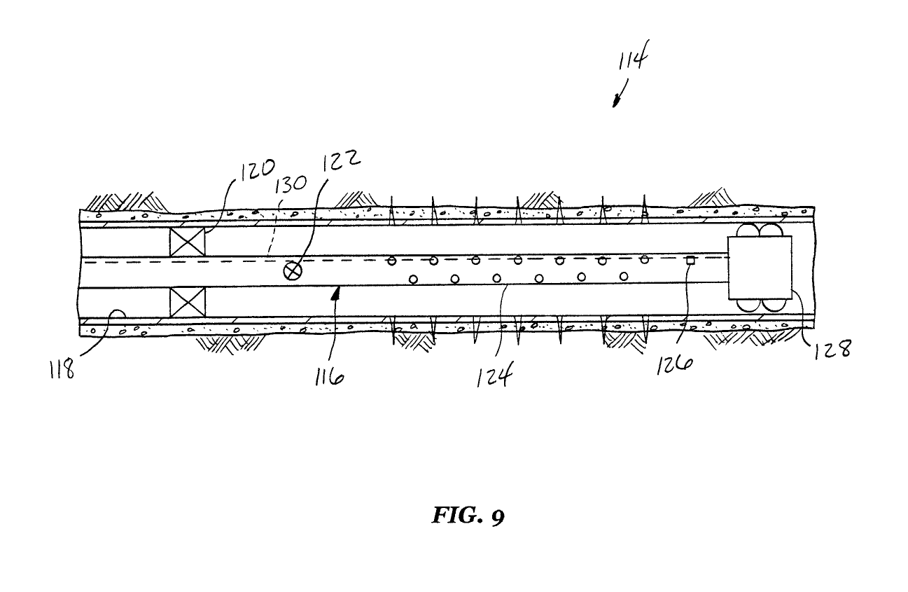

Referring additionally now to FIG. 9, a well production system 114 embodying principles of the present invention is representatively illustrated. The system 114 takes advantage of some of the features of the well screens described herein. However, it is to be clearly understood that principles of the present invention may be embodied in many different well production systems, and the description of the system 114 is given as merely an example of the wide variety of systems in which those principles may be used.

In the embodiment of the system 114 depicted in FIG. 9, a coiled tubing string 116 is conveyed into a wellbore 118. The tubing string 116 includes a packer 120, a flow control device such as a valve 122, a well screen 124, a sensor 126 and a tractor device 128. A suitable downhole tractor for use as the tractor device 128 is described in U.S. patent application Ser. No. 09/245,468, filed Feb. 5, 1999, the disclosure of which is incorporated herein in its entirety by this reference.

The coiled tubing string 116 preferably utilizes a composite tubing in which one or more lines 130 are embedded in a sidewall thereof. In many situations in which composite tubing is conveyed into a horizontal or highly deviated wellbore, the low density of the tubing makes it difficult to push the tubing through the wellbore. Thus, the tractor device 128 is used in the system 114 to convey the tubing string 116 through the wellbore 118.

The line 130 extends through the screen 124, as in the various well screens described herein, that is, the line extends through a sidewall of the screen. The ability to extend the line 130 through the screen 124, without the problems associated with running the line externally across the screen or internally through an axial flow passage of the screen, permits the tractor device 128 on the end of the tubing string 116 to be conveniently powered via the line.

The line 130 may also be used to receive indications of a parameter, such as pressure, temperature, etc., as sensed by the sensor 126 for monitoring well conditions, detecting the nature and makeup of fluid produced from the well, etc. The line 130 may also be used to actuate the valve 122 and/or the packer 120. Of course, if multiple lines 130 are provided, various of the lines may be used to perform separate functions. For example, a hydraulic line maybe used to set the packer 120, an electric line may be used to power the tractor device 128, a fiber optic line may be used for receiving indications from the sensor 126, etc.

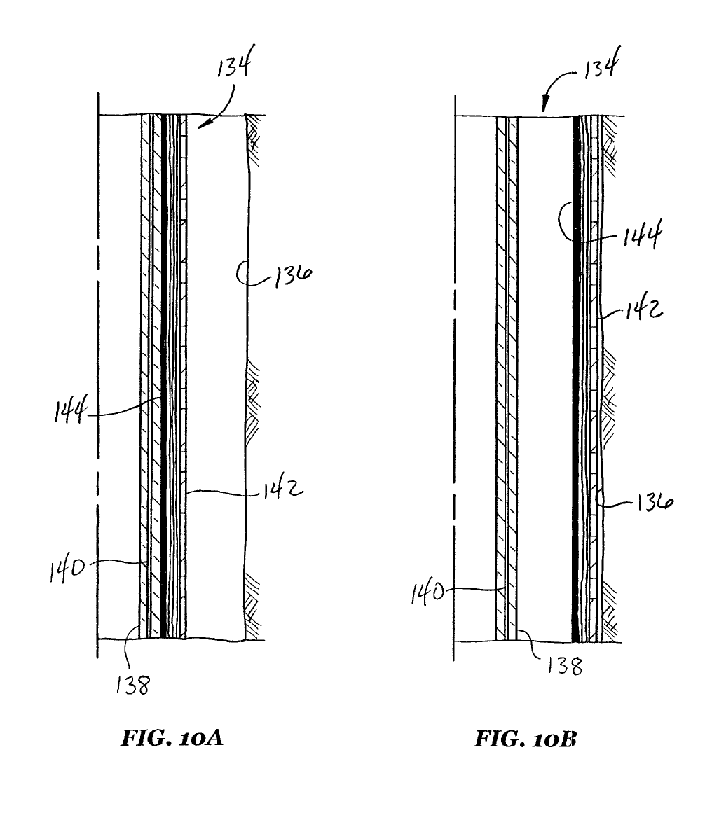

Referring additionally now to FIGS. 10A & B, another well screen 134 embodying principles of the present invention is representatively illustrated. The screen 134 is a radially expandable screen and is depicted in FIG. 10A in a wellbore 136 prior to being expanded, and is depicted in FIG. 10B after it has been expanded.

The screen 134 includes a body portion or base pipe 138 which is preferably made of a composite material and has one or more lines 140 embedded in a sidewall thereof. The base pipe 138 also has openings formed through its sidewall, which openings are not visible in FIGS. 10A & B, but which are similar to the openings 30 depicted in FIG. 3.

An expandable screen jacket 142 outwardly overlies the openings in the base pipe 138. An example of a well screen including a screen jacket being expanded is described in the incorporated U.S. patent application Ser. No. 09/574,658.

For expanding the screen jacket 142 of the screen 134, an inflatable membrane 144 is provided between the base pipe 138 and the screen jacket. Fluid pressure is applied to the interior of the base pipe 138 to inflate the membrane 144 via the openings in the base pipe sidewall. Inflation of the membrane 144 forces the screen jacket 142 radially outward relative to the base pipe 138.

The screen jacket 142 may be expanded outward into contact with the wellbore 136 as depicted in FIG. 10B, for example, to provide support for an unconsolidated formation surrounding the wellbore. The use of the expandable screen 134 may be useful in other situations as well, for example, to permit the screen to pass through a restriction in the wellbore 136 prior to being expanded.

As another example, the well screen 134 in its retracted configuration may have an outer diameter which is less than or approximately equal to the outer diameter of a coiled tubing string in which the screen is interconnected, so that the screen may be wrapped on a reel and deployed into the wellbore 136 using conventional injector equipment, and then expanded after the screen is appropriately positioned in the wellbore. The above are merely examples of a variety of situations in which use of the expandable screen 134 would be advantageous.

After the membrane 144 has been inflated, it is preferably dispensed with to permit fluid flow between the screen jacket 142 and the openings in the base pipe 138 sidewall. For example, a mechanism may be provided for withdrawing the membrane 144 from between the screen jacket 142 and the base pipe 138. As another example, the membrane 144 may be made of an acid soluble material, in which case an acid maybe circulated through the openings in the base pipe 138 to dissolve the membrane.

Note that a membrane similar to the membrane 144 may be incorporated into the other screens 24, 46, 56, 66, 84, 100, 124 described above, thereby making those screens also expandable.

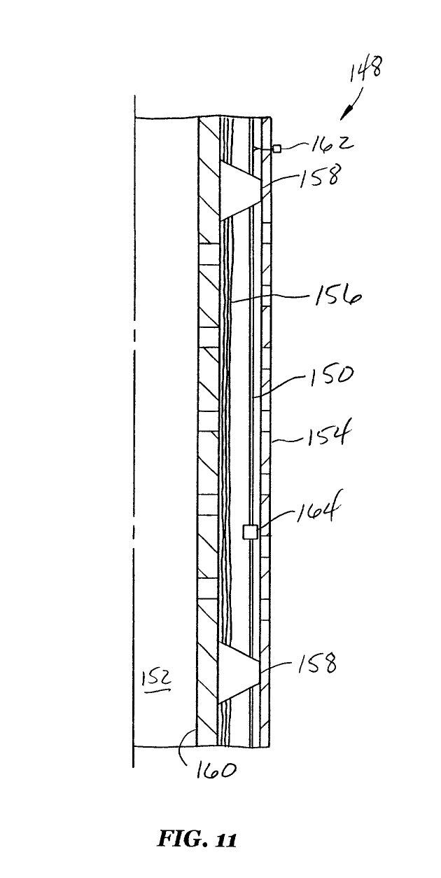

Referring additionally now to FIG. 11, another well screen 148 embodying principles of the present invention is representatively illustrated. The screen 148 includes at least one line 150 extending therethrough, but the line is not embedded in a sidewall material of the screen. Nevertheless, the line 150 is protected from damage, since it does not extend externally across the screen 148, nor does it extend within an internal axial flow passage 152 of the screen.

Instead, the line 150 extends within an annular space formed between an outer perforated shroud 154 and a filter media 156 of the screen 148. The annular space is maintained by centralizers 158 extending outwardly from a base pipe 160. The centralizers 158 may also be used to secure the line 150 in position in the annular space. The line 150 may be similar to any of the other lines 26, 70, 88, 130, 140 described above.

Sensors and/or actuators 162, 164 are connected to the line 150. Such sensors may be used to sense parameters internal or external to the screen 148, and such actuators maybe used, for example, to enhance distribution of gravel in a gravel packing operation. A description of the use of such sensors and actuators 162, 164 in conjunction with a well screen is given in U.S. application Ser. No. 09/615,016, filed Jul. 13, 2000, the disclosure of which is incorporated herein in its entirety by this reference.

Of course, a person skilled in the art would, upon a careful consideration of the above description of representative embodiments of the invention, readily appreciate that many modifications, additions, substitutions, deletions, and other changes may be made to these specific embodiments, and such changes are contemplated by the principles of the present invention. Accordingly, the foregoing detailed description is to be clearly understood as being given by way of illustration and example only, the spirit and scope of the present invention being limited solely by the appended claims.

What is claimed is:

1. A well screen, comprising:
a sidewall including a material; and
at least one line embedded in the sidewall material.

2. The well screen according to claim 1, wherein the line extends generally longitudinally through the sidewall.

3. The well screen according to claim 1, further comprising a filter media, and wherein the filter media is recessed in the sidewall.

4. The well screen according to claim 1, wherein the sidewall material is nonmetallic.

5. The well screen according to claim 4, wherein flow passages are formed through the sidewall, and further comprising a generally tubular protective shield lining each of the flow passages.

6. The well screen according to claim 5, further comprising a flexible retainer disposed between each shield and the respective flow passage.

7. The well screen according to claim 4, wherein the sidewall material is a composite material.

8. The well screen according to claim 1, further comprising a filter media, and wherein the filter media is expandable in a wellbore.

9. The well screen according to claim 1, further comprising at least one sensor connected to the line.

10. The well screen according to claim 9, wherein the sensor senses a parameter external to the well screen.

11. The well screen according to claim 9, wherein the sensor senses a parameter internal to the well screen.

12. The well screen according to claim 1, further comprising an actuator connected to the line.

13. The well screen according to claim 1, further comprising a flow control device connected to the line.

14. The well screen according to claim 1, wherein the line is a selected one of a communication line, an injection line, a power line, a control line and a monitoring line.

15. The well screen according to claim 1, wherein the line is a selected one of a hydraulic line, an electrical line and a fiber optic line.

16. A well screen deployment system, comprising:
a reel; and
at least one well screen wrapped on the reel.

17. The system according to claim 16, further comprising tubing wrapped on the reel, and wherein an outer dimension of the well screen is less than or approximately equal to an outer diameter of the tubing.

18. The system according to claim 17, wherein the tubing is nonmetallic.

19. The system according to claim 16, wherein the well screen includes a filter media, and wherein the filter media is recessed into a tubular body of the well screen.

20. The system according to claim 19, wherein the tubular body is a portion of a tubing wrapped on the reel.

21. The system according to claim 20, wherein the tubing is nonmetallic.

22. The system according to claim 16, wherein the well screen is wrapped in multiple revolutions about the reel.

23. The system according to claim 16, wherein the well screen is continuously formed on a tubing wrapped on the reel.

24. The system according to claim 23, wherein the well screen is formed on the tubing without severing the tubing.

25. The system according to claim 24, wherein the well screen comprises a portion of the tubing having openings formed through a sidewall of the tubing, the openings filtering fluid flowing into the tubing.

26. The system according to claim 25, wherein the tubing sidewall is made of a composite material.

27. The system according to claim 16, wherein the well screen is positioned on the reel corresponding to a predetermined desired location for the screen in a well.

28. The system according to claim 16, wherein there are multiple well screens, and wherein the well screens are spaced apart on the reel corresponding to predetermined desired spacings between the well screens in a well.

29. The system according to claim 16, wherein the well screen is expandable in a well.

30. The system according to claim 29, further comprising tubing wrapped on the reel, and wherein the well screen is expandable radially outward relative to the tubing, when the well screen and tubing are disposed in the well.

31. The system according to claim 16, further comprising at least one sensor connected to the line.

32. The well screen according to claim 31, wherein the sensor senses a parameter external to the well screen.

33. The well screen according to claim 31, wherein the sensor senses a parameter internal to the well screen.

34. The well screen according to claim 16, further comprising an actuator connected to the line.

35. The well screen according to claim 16, further comprising a flow control device connected to the line.

36. The well screen according to claim 16, wherein the line is a selected one of a communication line, an injection line, a power line, a control line and a monitoring line.

37. The well screen according to claim 16, wherein the line is a selected one of a hydraulic line, an electrical line and a fiber optic line.

38. A well production system for a well having a wellbore, the system comprising:
a coiled tubing string deployed into the wellbore, the coiled tubing string including at least one well screen, and the well screen including a line embedded in a sidewall material of the well screen.

39. The system according to claim 38, wherein the sidewall material is a composite material.

40. The system according to claim 38, further comprising a tractor device connected to the coiled tubing string, the tractor device conveying the coiled tubing string in the wellbore.

41. The system according to claim 40, wherein the line supplies power to the tractor device.

42. The system according to claim 38, further comprising a flow control device connected in the coiled tubing string, the flow control device being actuated via the line.

43. The system according to claim 38, further comprising at least one sensor attached to the coiled tubing string, indications of a parameter sensed by the sensor being communicated via the line.

44. The system according to claim 38, wherein the well screen is continuously formed on the coiled tubing string.

45. The system according to claim 38, wherein the well screen is formed on the coiled tubing string by openings extending through a sidewall of the coiled tubing string.

46. The system according to claim 45, wherein the coiled tubing string sidewall is made of a nonmetallic material.

47. The system according to claim 45, wherein the coiled tubing string sidewall is made of a composite material.

48. The system according to claim 38, wherein the well screen includes a filter media recessed into a tubular body of the well screen.

49. The system according to claim 48, wherein an outer dimension of the filter media is less than or approximately equal to an outer diameter of a tubing portion of the coiled tubing string.

50. The system according to claim 38, wherein the well screen is expandable in the wellbore.

51. The system according to claim 38, further comprising at least one actuator attached to the coiled tubing string, the actuator being connected to the line.

52. The system according to claim 38, wherein the coiled tubing string includes a flow control device actuated via the line.

53. The system according to claim 38, wherein the line is a selected one of a communication line, an injection line, a power line, a control line and a monitoring line.

54. The system according to claim 38, wherein the line is a selected one of a hydraulic line, an electrical line and a fiber optic line.

55. A well production system for a well having a wellbore, the system comprising:
a coiled tubing string deployed into the wellbore, the coiled tubing string including at least one well screen, and the well screen being expandable in the wellbore.

56. The system according to claim 55, wherein the well screen is expandable radially outward relative to a tubing portion of the coiled tubing string.

57. The system according to claim 55, wherein the well screen includes a line embedded in a sidewall material of the well screen.

58. The system according to claim 55, wherein the well screen includes a tubular body portion made of a composite material.

59. The system according to claim 55, wherein the well screen is continuously formed on tubing of the coiled tubing string.

60. The system according to claim 55, wherein the well screen has an outer dimension which is less than or approximately equal to an outer diameter of a tubing portion of the coiled tubing string.

61. A well screen, comprising:
a filter media;
an outer shroud outwardly overlying the filter media; and
a line extending between the filter media and the outer shroud.

62. The well screen according to claim 61, wherein the line is a selected one of a communication line, an injection line, a power line, a control line and a monitoring line.

63. The well screen according to claim 61, wherein the line is a selected one of a hydraulic line, an electrical line and a fiber optic line.

64. The well screen according to claim 61, further comprising at least one sensor connected to the line.

65. The well screen according to claim 64, wherein the sensor senses a parameter internal to the well screen.

66. The well screen according to claim 64, wherein the sensor senses a parameter external to the well screen.

67. The well screen according to claim 61, further comprising an actuator connected to the line.
